(19) United States
(12) Patent Application Publication
(10) Pub. No.: US 2026/0170408 A1
(43) Pub. Date: Jun. 18, 2026

(54) SIMULTANEOUS WEIGHTED PREFERENCE OPTIMIZATION FOR GROUP CONTRASTIVE ALIGNMENT

(71) Applicant: Microsoft Technology Licensing, LLC, Redmond, WA (US)

(72) Inventors: Taneesh GUPTA, Bengaluru (IN); Rahul MADHAVAN, Bangalore (IN); Xuchao ZHANG, Sammamish, WA (US); Chetan BANSAL, Seattle, WA (US); Saravanakumar RAJMOHAN, Redmond, WA (US)

(21) Appl. No.: 19/072,441

(22) Filed: Mar. 6, 2025

(30) Foreign Application Priority Data
Dec. 17, 2024 (IN) 202441099877

(51) Int. Cl. G06N 20/00

(52) U.S. Cl. CPC G06N 20/00

(57) ABSTRACT

Simultaneous Weighted Preference Optimization (SWEPO) is a method for enhancing machine learning model alignment by addressing alignment biases. This approach involves calculating mean reward scores for multiple responses to a query, computing deviations, and assigning weights based on these deviations. The method partitions responses into positive and negative sets, generating a weighted contrastive loss function to optimize model parameters. This process prioritizes responses with significant deviations, improving model performance by focusing on the most informative examples. The system can be implemented on a single or distributed computing architecture, facilitating efficient training and inference processes.

### PRIORITY CLAIM

This patent application claims the benefit of priority, under 35 U.S.C. Section 119 to Indian Provisional Application No. 202441099877, entitled “SWEPO: Simultaneous Weighted Preference Optimization for Group Contrastive Alignment,” filed on Dec. 17, 2024 which is hereby incorporated by reference herein in its entirety.

### TECHNICAL FIELD

Embodiments pertain to artificial intelligence and machine learning technologies. Some embodiments relate to preference optimization methods for enhancing model alignment by reducing alignment biases.

### BACKGROUND

Machine learning models are computational algorithms designed to identify patterns and make decisions based on data. These models are integral to a wide range of applications, including natural language processing, image recognition, and predictive analytics. By learning from large datasets, machine learning models can improve their performance over time, making them valuable tools in various industries such as healthcare, finance, and technology.

One of the key challenges in developing machine learning models is ensuring that they align with specific performance criteria and expectations such as human expectations. This alignment is crucial for applications where the model's output directly impacts operational efficiency or decision-making processes. To address this, various techniques have been developed to optimize model parameters based on preference data.

Direct Preference Optimization (DPO) is a method that simplifies the alignment process by directly optimizing a contrastive loss over paired preference data. Unlike traditional reinforcement learning approaches, DPO does not require explicit reward functions, making it computationally efficient and suitable for datasets with limited preference annotations. This method has become a cornerstone in aligning models with predefined criteria, enabling them to generate outputs that are more consistent with desired outcomes.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a machine-learning model system according to some examples of the present disclosure.

FIG. 2 shows a logical diagram of a SWEPO training process according to some examples of the present disclosure.

FIG. 3 illustrates a flowchart of a method of training a model using SWEPO according to some examples of the present disclosure.

FIG. 4 shows a computing device with a training component to train a model along with an inference component that uses the model to produce responses to queries according to some examples of the present disclosure.

FIG. 5 illustrates a block diagram of an example machine upon which any one or more of the techniques discussed herein may be performed according to some examples of the present disclosure.

### DETAILED DESCRIPTION

Training and aligning language models face several significant challenges. The traditional approaches that rely on pairwise comparisons between responses provide an incomplete picture of what makes responses truly optimal or suboptimal. When models only see two examples at a time-one preferred and one non-preferred-they can end up overfitting to specific characteristics rather than learning the broader patterns that reflect genuine quality differences.

The current methods also struggle to make full use of available training data, particularly when there are multiple responses of varying quality levels. Simply categorizing responses as acceptable or unacceptable misses crucial information about how much better or worse certain responses are compared to others. This is especially problematic when working with datasets that include detailed quality ratings, as valuable training signals from exceptionally high-quality or notably low-quality responses get overlooked.

In addition, when training datasets contain several responses for each query along with scalar quality scores, existing approaches either have to discard useful information or resort to computationally expensive methods of comparing all possible response combinations. This leads to inefficient use of training resources and potentially missed opportunities for better model optimization.

These limitations in current approaches result in models that may not fully capture the nuances of response quality and may not make optimal use of available training data.

Disclosed in some examples are methods, systems, devices, and machine-readable mediums which optimize language model training by incorporating multiple responses with varying quality levels through weighted group contrastive alignment in an approach called Simultaneous Weighted Preference Optimization. The methods enable more effective model training by considering the full spectrum of response quality rather than simple binary comparisons, leading to improved model performance and more efficient use of training data.

These methods solve the above-mentioned optimization challenges by first calculating mean reward scores from multiple responses associated with each query. For each response, deviations from the mean reward score are computed and used to partition responses into positive and negative sets. The responses are then weighted based on their deviation from the mean, with greater weight given to responses that deviate more significantly from the average quality. These weights are incorporated into a weighted contrastive loss function that simultaneously considers multiple positive and negative responses. The loss function is then used to update the model parameters through optimization, resulting in a model that better captures the full spectrum of response quality. This approach enables more nuanced training by emphasizing responses that are notably better or worse than average, while still maintaining the contribution of responses closer to the mean quality level.

The technical problem addressed by the disclosed invention is the challenge of alignment bias in machine learning models, particularly in effectively capturing the diverse range of acceptable and suboptimal responses to a given query. Traditional methods often rely on pairwise comparisons, which can be limiting when dealing with datasets containing multiple positive and negative responses per query, leading to biases such as length, format, and cultural biases. The technical solution provided by the invention is the Simultaneous Weighted Preference Optimization (SWEPO) method, which employs a weighted group contrastive loss function to assign weights to responses based on their deviation from the mean reward score. This approach allows for the simultaneous consideration of multiple preferences, reducing alignment bias and improving the model's ability to align with a broader spectrum of criteria by prioritizing the most informative examples during training.

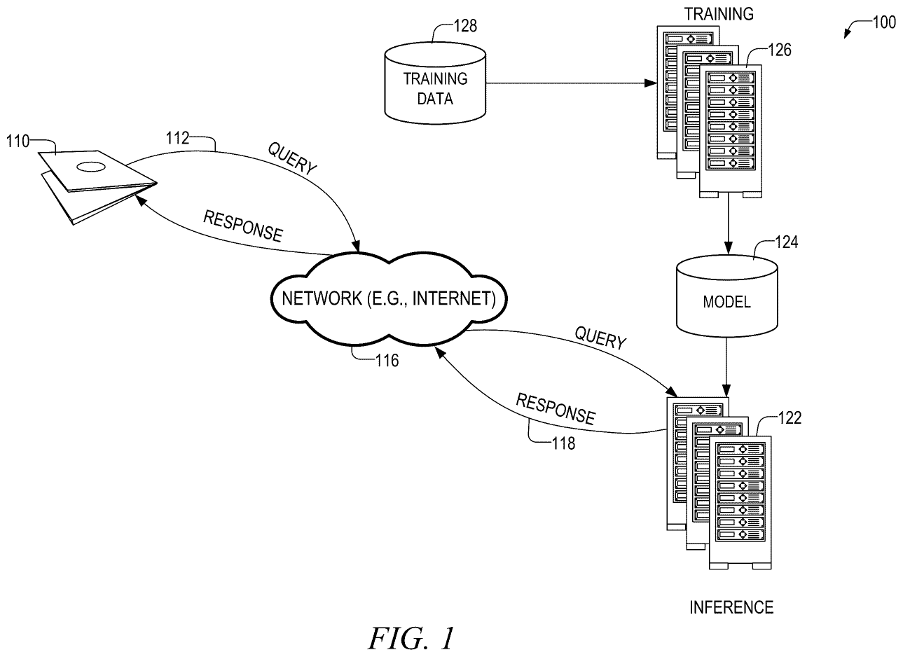

FIG. 1 shows a machine-learning model system 100 according to some examples of the present disclosure. The system 100 includes a user computing device 110, which is configured to send a query 112 over a network 116, such as the Internet. The network 116 facilitates communication between the user computing device 110 and an inference service 122, which processes the query 112 and generates a response 118. This response 118 is then transmitted back to the user computing device 110. In some examples, the query 112 may be a prompt and the response 118 may be text, images, videos, or the like. In some examples the inference service 122 executes on one or more server computing devices.

The inference services 122 uses a model 124 to generate the response 118 from the query 120. For example, the model 124 may be a generative Artificial Intelligence model such as a language model. Example language models may include large language models (LLMs). The model 124 is trained using a training service 126, which utilizes training data 128 to create model 124. In some examples, this process involves learning weights and biases of neurons within a neural network. In some examples, the training service 126 may utilize the SWEPO method disclosed herein. In some examples the training service 126 executes on one or more server computing devices.

In some examples, the training service 126 and the inference service 122 may be implemented on the same computing system. This configuration allows for seamless integration between training and inference processes, enabling real-time updates to the model 124 as new training data 128 becomes available. By sharing computational resources, this setup can reduce latency and improve the efficiency of model updates, ensuring that the model 124 remains current and responsive to evolving data patterns and user queries.

Alternatively, the training service 126 and the inference service 122 may be deployed on separate computing systems. This separation can be advantageous in scenarios where the training process requires significant computational power and resources, which may not be feasible to maintain on the same system as the inference component. By distributing the workload across different systems, organizations can optimize resource allocation, ensuring that both training and inference processes operate efficiently. This configuration also allows for greater flexibility in scaling each component independently, accommodating varying demands for training and inference tasks.

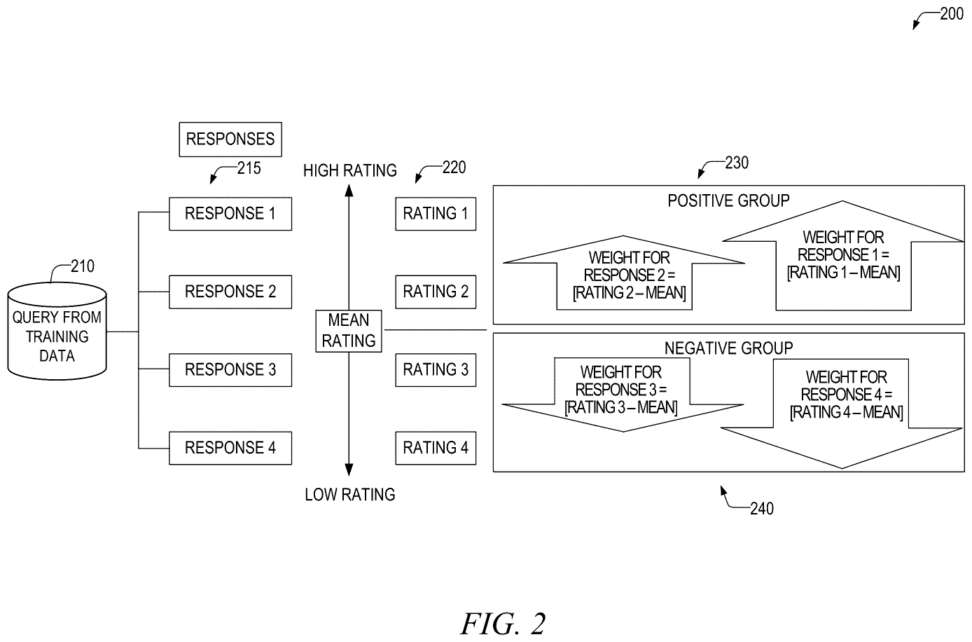

FIG. 2 shows a logical diagram of a SWEPO training process 200 according to some examples of the present disclosure. The process begins with identifying a query 210 from training data, along with multiple associated responses 215. In this example, four responses are identified: Response 1, Response 2, Response 3, and Response 4. In some examples, the responses may be part of the training data and associated within the training data with the query. In other examples the responses may be generated by one or more generative AI models (such as an LLM).

Each response is associated with a rating 220, which reflects its quality or relevance to the query. In some examples, the ratings may be specified as part of the training data. In other examples, the ratings may be generated by one or more generative AI models (such as an LLM). In examples in which the responses are generated by generative AI models, the ratings may be generated by the same or by different generative AI models.

The ratings 220 are then used to calculate a mean rating and each rating is then compared against a calculated mean rating to determine a relative standing of each response. Responses with ratings above the mean are categorized into a positive group 230, while those below the mean are placed in a negative group 240. The positive group 230 includes responses that are considered better than average. For each response in this group, a weight is calculated based on the deviation of the rating from the mean. For example, the weight may be the rating of the response minus the mean. Conversely, the negative group 240 consists of responses that are below the mean rating. Weights for these responses are also calculated using their deviation from the mean, but in this case, the focus is on how much they fall short of the average. This weighting mechanism allows the model to prioritize responses that are significantly better or worse than average, thereby enhancing the training process by focusing on the most informative examples.

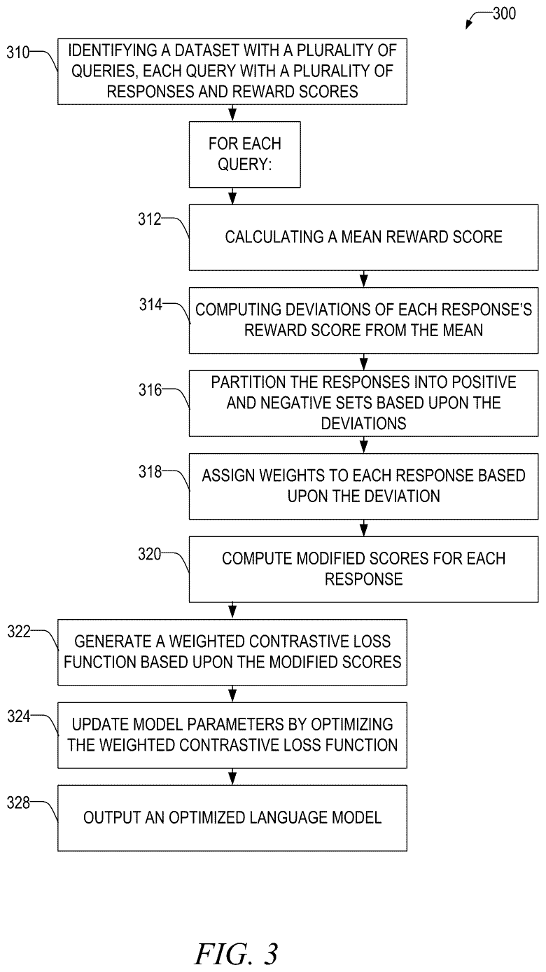

FIG. 3 shows a flowchart of a method 300 for training a model using Simultaneous Weighted Preference Optimization (SWEPO) according to some examples of the present disclosure. At operation 310, the method begins by identifying a dataset with a plurality of queries, each query associated with a plurality of responses and corresponding reward scores. In some examples, the dataset may be created manually. In other examples, the dataset may be created using an AI model to automatically generate corresponding response labels through multiple sampling. At operation 312, for each query, a mean reward score is calculated. This mean score serves as a benchmark against which individual response scores are compared. Following this, operation 314 involves computing the deviations of each response's reward score from the mean. These deviations quantify how each response compares to the average, providing a metric which indicates which responses are outliers in terms of quality.

Operation 316 partitions the responses into positive and negative sets based upon the computed deviations. Responses with scores above the mean are categorized as positive, while those below the mean are considered negative. In operation 318, weights are assigned to each response based upon the deviation from the mean. Responses that deviate more significantly from the mean, either positively or negatively, are given greater weight. This weighting mechanism ensures that the most informative responses have a more substantial impact on the model's training process.

In operation 318, weights are assigned to each response based on the deviation of its reward score from the mean reward score. The calculation of these weights involves using either an exponential function or a power function to emphasize responses that deviate significantly from the mean. For positive responses, where the deviation is greater than zero, the weight wᵢ can be calculated as exp (αΔSᵢ) or (ΔSᵢ)^{p}, where a is a scaling hyperparameter and p is a power parameter that can take values such as 0, 1, or 2; and where ΔSᵢ is the deviation of a response's reward score from the mean reward score for a given query. Similarly, for negative responses, where the deviation is less than or equal to zero, the weight wᵢ can be calculated as exp (α(−ΔSi)) or (−ΔSi)^{p}. This weighting mechanism ensures that responses with larger deviations, whether positive or negative, have a greater influence on the model's training process, thereby prioritizing the most informative examples.

In operation 320, the modified scores for each response are computed by incorporating the weights calculated in operation 318. These modified scores are used to generate a weighted contrastive loss function, which is used to optimize the model's parameters. The modified score for each response is calculated by adjusting the original score of the response with the weight assigned to it. Mathematically, the modified score

$${s}_{θ}^{′} ( {y}_{i} \vert x )$$

for a response yᵢ given a query x is expressed as:

$${s}_{θ}^{′} ( {y}_{i} \vert x ) = {S}_{θ} ( {y}_{i} \vert x ) + α Δ {S}_{i}$$

Where S_{θ}(yᵢ|x) is the original score or logit of the response, a is a scaling hyperparameter, and ΔSᵢ is the deviation of the response's reward score from the mean, as calculated in operation 318. The weight wᵢ is incorporated into the score by adding the product of the scaling hyperparameter α and the deviation ΔSᵢ to the original score. While the weights calculated in operation 318 are This adjustment ensures that responses with larger deviations, whether positive or negative, have a greater influence on the model's training process, thereby prioritizing the most informative examples. Note that when incorporating the weights into the conditional probabilities of the language model, the exponential function used in the weight calculation is effectively removed. This is because the weights are applied directly to the probabilities, which are already in an exponential form due to the nature of the softmax function used in calculating probabilities from logits that are the raw, unnormalized scores output by a model's final layer prior to a softmax function.

These modified scores are used to generate a weighted contrastive loss function at operation 322. The weighted contrastive loss function is designed to simultaneously consider multiple positive and negative responses, optimizing the model's parameters to better align with the full spectrum of response quality. In some examples, the weighted contrastive loss function is given by:

$${L}_{Weighted} ( θ ) = - log \frac{{\sum }_{y ∈ {Y}^{+}} exp ( {s}_{θ}^{′} ( y \vert x ) )}{{\sum }_{y ∈ Y} exp ( {s}_{θ}^{′} ( y \vert x ) )}$$

Where: Where Y=Y⁺∪Y⁻ and where

$${s}_{θ}^{′} ( y \vert x )$$

is the modified score for response y given query x incorporating the weight calculated from the deviation of the response's reward score from the mean. The numerator of the loss function sums the exponentiated modified scores of the positive responses, emphasizing their contribution to the optimization process. The denominator sums the exponentiated modified scores of all responses, ensuring that the loss function considers the relative quality of both positive and negative responses.

In operations 324 and 326, the model parameters are optimized by minimizing the weighted contrastive loss function generated in operation 322. This optimization process involves iteratively adjusting the model's parameters to reduce the loss, thereby improving the model's ability to distinguish between high-quality and low-quality responses. The optimization may be performed using a gradient descent algorithm or one of its variants, such as stochastic gradient descent (SGD) or Adam. These algorithms work by calculating the gradient of the loss function with respect to the model parameters and updating the parameters in the direction that reduces the loss. The update rule can be expressed as:

$$θ ← θ - η {∇}_{θ} {L}_{weighted} ( θ )$$

Where θ represents the model parameters, η is the learning rate, and ∇_{θ}L_{weighted}(θ) is the gradient of the weighted contrastive loss function with respect to the model parameters. By iteratively applying this update rule, the model's parameters are refined to better capture the nuances of response quality, leading to improved alignment with the desired criteria. This process continues until the loss converges to a minimum or a predefined number of iterations is reached, resulting in an optimized model that is more effective in generating outputs aligned with specified performance criteria.

At operation 328, the method outputs an optimized language model. This optimized model is expected to exhibit improved alignment with human preferences, as it has been trained using a comprehensive approach that considers multiple responses and their relative quality. In some examples, the model may be used in an inference service (such as inference service 122) to provide summaries of documents, question answering, generating content, translations, code generation and understanding, data analysis, and the like.

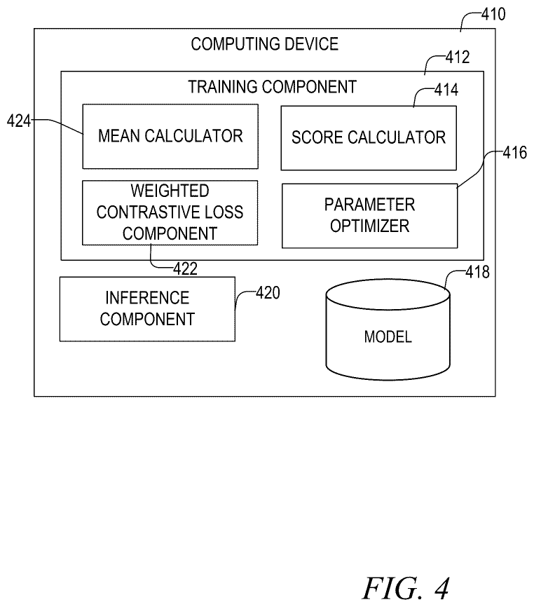

FIG. 4 shows a computing device 410 that incorporates a training component 412 and an inference component 420 according to some examples of the present disclosure. The training component 412 is responsible for training a model 424, which is subsequently used by the inference component 420 to generate responses to queries. The training component 412 includes several sub-components that work together to optimize the model 424. A mean calculator 414 is utilized to compute the mean reward scores from multiple responses associated with each query. A score calculator 416 is employed to compute the deviations of each response's reward score from the mean. These deviations are used to partition responses into positive and negative sets, which are used in the weighted contrastive loss function.

The weighted contrastive loss component 422 integrates the calculated weights into a loss function that simultaneously considers multiple positive and negative responses. This component ensures that the model 424 is trained to prioritize responses that are significantly better or worse than average, enhancing the model's alignment with human preferences.

A parameter optimizer 418 updates the model parameters based on the weighted contrastive loss function. This iterative optimization process refines the model's ability to distinguish between high-quality and low-quality responses, leading to improved performance.

The inference component 420 utilizes the trained model 424 to produce responses to queries. This component ensures that the model's outputs are aligned with the preferences and expectations defined during the training process, making the system responsive and effective in real-world applications. In some examples, the inference component 420 may be implemented in a separate computing device from computing device 410.

### Additional Details

Let X denote the set of all possible queries, with x∈X denoting a specific query. For each query x let Yₓ be the set of all potential responses. The dataset D consists of N queries, where each query x is associated with n responses

$${\{ {y}_{i} \}}_{i = 1}^{n}$$

and corresponding reward scores

$${\{ {S}_{i} \}}_{i = 1}^{n} .$$

The mean reward score for query x is calculated as:

$${S}_{m e a n} = \frac{1}{n} {\sum }_{i = 1}^{n} {S}_{i}$$

The deviation of each response's reward score from the mean is given by:

$$Δ {S}_{i} = {S}_{i} - {S}_{m e a n}$$

The responses are then partitioned into positive and negative sets:

$${Y}^{+} = \{ {y}_{i} \vert Δ {S}_{i} > 0 \} ,$$

$${Y}^{-} = \{ {y}_{i} \vert Δ {S}_{i} \leq 0 \} .$$

Weights are then assigned based upon the deviation, using an exponential function or a power function. For positive responses (yᵢ∈Y⁺):

$${w}_{i}^{+} = exp ( α Δ {S}_{i} ) or {w}_{i}^{+} = {( Δ {S}_{i} )}^{p} ,$$

And for negative responses (yⱼ∈Y⁻):

$${w}_{j}^{-} = exp ( α ( - Δ {S}_{j} ) ) or {w}_{j}^{-} = {( Δ {S}_{j} )}^{p} ,$$

Where α>0 is a scaling hyperparameter and p∈{0, 1, 2}.

The language model parameterized by θ provides the conditional probability P_{θ}(y|x) of generating response y given query x. The logit or score function is:

$${S}_{θ} ( y \vert x ) = log ( \frac{{P}_{θ} ( y \vert x )}{{P}_{ref} ( y \vert x )} ) = log {P}_{θ} ( y \vert x ) - log {P}_{ref} ( y \vert x ) .$$

Incorporating the weights into the probabilities yields:

$${w}_{i} * exp ( {s}_{θ} ( {y}_{i} \vert x ) ) = exp ( α Δ {S}_{i} + {s}_{θ} ( {y}_{i} \vert x ) ) ,$$

This leads to the modified score of:

$${s}_{θ}^{′} ( {y}_{i} \vert x ) = {s}_{θ} ( {y}_{i} \vert x ) + α Δ {S}_{i} .$$

The weighted contrastive loss function is defined as:

$${L}_{weighted} ( θ ) = - log \frac{{\sum }_{y ∈ {Y}^{+}} exp ( {s}_{θ}^{′} ( y \vert x ) )}{{\sum }_{y ∈ Y} exp ( {s}_{θ}^{′} ( y \vert x ) )}$$

$$Where Y = {Y}^{+} ⋃ {Y}^{-} .$$

### Example Algorithm

```
    Input: Initial model parameters θₒ; dataset D with n responses and
reward scores per query; scaling hyperparameter α, power p ∈ {0, 1, 2},
iterations T.
    Output: Optimized model parameters θ_{T}
Initialize θ ← θₒ;
For t ← 1 to T do
  Foreach query x ∈ D do
      Compute Sₘₑₐₙ, deviations ΔSᵢ, and partition responses into Y⁺ and
      Y⁻;
      $Assign weights : {w}_{i}^{+} = {( Δ {S}_{i} )}^{p} , {w}_{j}^{-} = {( Δ {S}_{j} )}^{p} ;$
      Compute scores: s_{θ}(y|x) = log(P_{θ}(y|x) − P_{ref}(y|x));
      $Compute modified scores : {s}_{θ}^{′} ( y \vert x ) = {s}_{θ} ( y \vert x ) + α Δ S ;$
    End foreach
    Compute loss:
        ${L}_{weighted} ( θ ) = - log \frac{{\sum }_{y ∈ {Y}^{+}} exp ( {s}_{θ}^{′} ( y \vert x ) )}{{\sum }_{y ∈ {Y}^{+} ⋃ {Y}^{-}} exp ( {s}_{θ}^{′} ( y \vert x ) )}$
    Update model parameters: θ ← θ − η∇_{θ}L_{weighted}(θ);
End
Return θ
```

### Weight Computation and Modified Scores

The weights were defined previously using an exponential function of the deviation ΔSᵢ. Specifically, the weight for each response is:

$${w}_{i} = exp ( α Δ {S}_{i} ) ,$$

For positive responses, and

$${w}_{j} = exp ( α ( - Δ {S}_{j} ) )$$

For negative responses.

By incorporating the weights into the loss function, it may be observed that:

$${w}_{i} * exp ( {s}_{θ} ( {y}_{i} \vert x ) ) = exp ( α Δ {S}_{i} + {s}_{θ} ( {y}_{i} \vert x ) ) .$$

This demonstrates that weighting the probabilities is equivalent to adjusting the logits by adding the scaled deviation. Thus, the modified score for each response becomes:

$${s}_{θ}^{′} ( {y}_{i} \vert x ) = {s}_{θ} ( {y}_{i} \vert x ) + α Δ {S}_{i} .$$

Generalization with Power P

In the algorithm, the weighting scheme was generalized by defining the weights as the p-th power of the deviation:

$$\begin{matrix}{w}_{i}^{+} = {( Δ {S}_{i} )}^{p} , & for {y}_{i} ∈ {Y}^{+}\end{matrix} ,$$

$$\begin{matrix}{w}_{j}^{-} = {( - Δ {S}_{j} )}^{p} , & for\end{matrix} {y}_{j} ∈ {Y}^{-} ,$$

Where p∈{0, 1, 2}. This allows flexibility in modifying the impact of the deviation on the weights. When p=0, all weights are equal to 1, reducing the method to unweighted contrastive loss.

Example Code

| | |
|---|---|
| 1 | import torch |
| 2 | |
| 3 | def swepo_loss ( pi_logps , ref_logps , rewards , beta , alpha , weight_type ) |
| | : |
| 4 | “““ |
| 5 | pi_logps : policy logprobs for K responses , shape ( Batch_Size , K) |
| 6 | ref_logps : reference logprobs for K responses , shape ( Batch_Size , |
| | K) |
| 7 | rewards : reward labels for K responses , shape ( Batch_Size , K) |
| 8 | beta : Temperature parameter for the SWEPO loss |
| 9 | alpha : rating weight |
| 10 | norm : weighting scheme for the reward score (0 or 1 or 2) |
| 11 | ””” |
| 12 | |
| 13 | logits = pi_logps − ref_logps # Compute logits |
| 14 | rewards = rewards / alpha # Normalizing the reward value to logits |
| | scale |
| 15 | |
| 16 | mean_rewards = torch . mean ( rewards , dim = −1) |
| 17 | if self . norm > 0: |
| 18 | weights = torch .abs( rewards − mean_rewards . reshape (−1, 1)) |
| 19 | weights = torch .pow( weights , norm ) * beta |
| 20 | else : |
| 21 | deviation_reward = 0 |
| 22 | |
| 23 | pos_mask = ( rewards > mean_rewards . reshape (−1, 1)) * 1 |
| 24 | neg_mask = torch . logical_not ( pos_mask ) * 1 |
| 25 | |
| 26 | eps = 1e −10 |
| 27 | logits = ( logits + weight ) * beta |
| 28 | logits = logits − logits .max(dim =−1, keepdim = True )[0] # Stabilize |
| | logits |
| 29 | softmax_val = torch . softmax ( logits + eps , dim = −1) |
| 30 | pos_sum = torch . clamp ( torch .sum( softmax_val * pos_mask , dim = −1), |
| | min =eps) |
| 31 | neg_sum = torch . clamp ( torch .sum( softmax_val * neg_mask , dim = −1), |
| | min =eps) |
| 32 | |
| 33 | losses = −1 * torch .log( pos_sum / ( pos_sum + neg_sum + eps * 2)) |
| 34 | |
| 35 | return losses . mean ( ) |

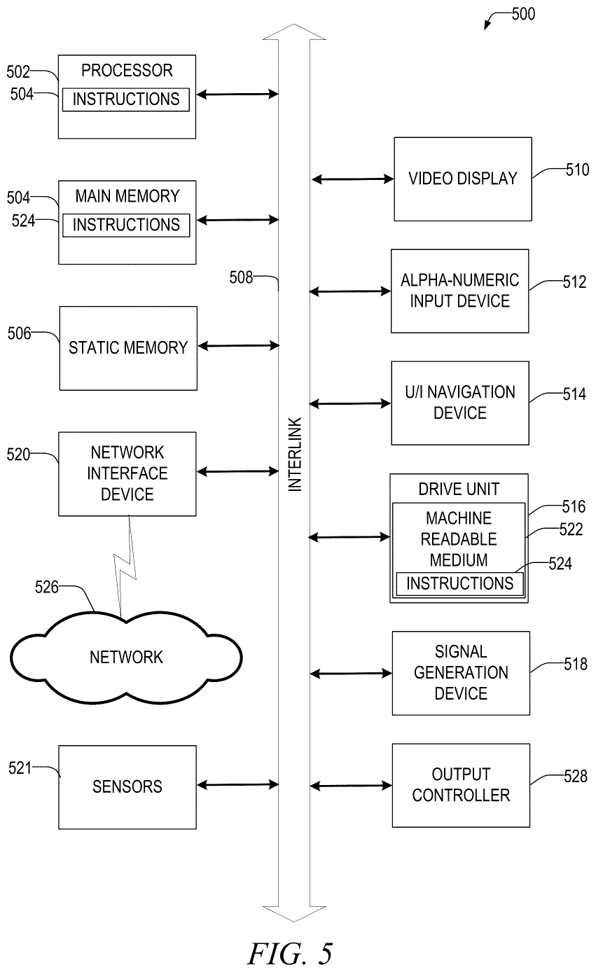

FIG. 5 illustrates a block diagram of an example machine 500 upon which any one or more of the techniques (e.g., methodologies) discussed herein may be performed. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be in the form of a server, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 500 may include one or more hardware processors, such as processor 502. Processor 502 may be a central processing unit (CPU), a graphics processing unit (GPU), a hardware processor core, or any combination thereof. Machine 500 may include a main memory 504 and a static memory 506, some or all of which may communicate with each other via an interlink (e.g., bus) 508. Examples of main memory 504 may include Synchronous Dynamic Random-Access Memory (SDRAM), such as Double Data Rate memory, such as DDR4 or DDR5. Interlink 508 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

What is claimed is:

1. A method for reducing alignment biases in training a machine-learning model, the method comprising:
identifying a dataset comprising a plurality of queries, wherein each query is associated with a plurality of responses and corresponding reward scores;
for each query:
calculating a mean reward score from the reward scores of associated responses;
computing deviations of each response's reward score from the mean reward score;
partitioning the responses into positive and negative sets by assigning responses with deviations above the mean reward score to the positive set and responses with deviations below or equal to the mean reward score to the negative set;
assigning weights to each response based on its deviation from the mean reward score, wherein responses with larger absolute deviations from the mean reward score are assigned higher weights than responses with smaller absolute deviations from the mean reward score, thereby emphasizing responses that are significantly better or worse than average during optimization; and
computing modified scores for each response by combining a base score with the assigned weight;
generating a weighted contrastive loss function based on the modified scores of the responses in the positive and negative sets;
updating model parameters of the machine-learning model by optimizing the weighted contrastive loss function; and
updating the model parameters of the machine-learning model to produce an optimized model having the updated model parameters.

2. The method of claim 1, wherein the weights assigned to each response are computed using an exponential function of the deviation from the mean reward score.

3. The method of claim 1, wherein the model parameters are updated using a gradient descent optimization algorithm.

4. The method of claim 1, wherein the weighted contrastive loss function incorporates a temperature parameter to control an influence of the deviation from the mean reward score.

5. The method of claim 1, wherein the method further comprises:
receiving an input query;
applying the input query to the optimized model to produce a response; and
outputting the response.

6. The method of claim 1, wherein the machine-learning model is a language model.

7. The method of claim 1, wherein the weighted contrastive loss function is computed using a group contrastive approach that simultaneously considers all responses in the positive and negative sets.

8. A computing device for reducing alignment biases in training a machine-learning model, the computing device comprising:
a hardware processor;
a memory, the memory storing instructions, which when executed by the hardware processor cause the computing device to perform operations comprising:
identifying a dataset comprising a plurality of queries, wherein each query is associated with a plurality of responses and corresponding reward scores;
for each query:
calculating a mean reward score from the reward scores of associated responses;
computing deviations of each response's reward score from the mean reward score;
partitioning the responses into positive and negative sets by assigning responses with deviations above the mean reward score to the positive set and responses with deviations below or equal to the mean reward score to the negative set;
assigning weights to each response based on its deviation from the mean reward score, wherein responses with larger absolute deviations from the mean reward score are assigned higher weights than responses with smaller absolute deviations from the mean reward score, thereby emphasizing responses that are significantly better or worse than average during optimization; and
computing modified scores for each response by combining a base score with the assigned weight;
generating a weighted contrastive loss function based on the modified scores of the responses in the positive and negative sets;
updating model parameters of the machine-learning model by optimizing the weighted contrastive loss function; and
updating the model parameters of the machine-learning model to produce an optimized model having the updated model parameters.

9. The computing device of claim 8, wherein the operation of assigning weights to each response is computed using an exponential function of the deviation from the mean reward score.

10. The computing device of claim 8, wherein the operations further comprise:
updating the model parameters using a gradient descent optimization algorithm.

11. The computing device of claim 8, wherein the operation of generating a weighted contrastive loss function incorporates a temperature parameter to control an influence of the deviation from the mean reward score.

12. The computing device of claim 8, wherein the operations further comprise:
receiving an input query;
applying the input query to the optimized model to produce a response; and
outputting the response.

13. The computing device of claim 8, wherein the machine-learning model is a language model.

14. The computing device of claim 8, wherein the operation of generating a weighted contrastive loss function is computed using a group contrastive approach that simultaneously considers all responses in the positive and negative sets.

15. A non-transitory machine-readable medium, storing instructions for reducing alignment biases in training a machine-learning model, the instructions, which when executed, cause the machine to perform operations comprising:
identifying a dataset comprising a plurality of queries, wherein each query is associated with a plurality of responses and corresponding reward scores;
for each query:
calculating a mean reward score from the reward scores of associated responses;
computing deviations of each response's reward score from the mean reward score;
partitioning the responses into positive and negative sets by assigning responses with deviations above the mean reward score to the positive set and responses with deviations below or equal to the mean reward score to the negative set;
assigning weights to each response based on its deviation from the mean reward score, wherein responses with larger absolute deviations from the mean reward score are assigned higher weights than responses with smaller absolute deviations from the mean reward score, thereby emphasizing responses that are significantly better or worse than average during optimization; and
computing modified scores for each response by combining a base score with the assigned weight;
generating a weighted contrastive loss function based on the modified scores of the responses in the positive and negative sets;
updating model parameters of the machine-learning model by optimizing the weighted contrastive loss function; and
updating the model parameters of the machine-learning model to produce an optimized model having the updated model parameters.

16. The non-transitory machine-readable medium of claim 15, wherein the operation of assigning weights to each response is computed using an exponential function of the deviation from the mean reward score.

17. The non-transitory machine-readable medium of claim 15, wherein the operations further comprise:
updating the model parameters using a gradient descent optimization algorithm.

18. The non-transitory machine-readable medium of claim 15, wherein the operation of generating a weighted contrastive loss function incorporates a temperature parameter to control an influence of the deviation from the mean reward score.

19. The non-transitory machine-readable medium of claim 15, wherein the operations further comprise:
receiving an input query;
applying the input query to the optimized model to produce a response; and
outputting the response.

20. The non-transitory machine-readable medium of claim 15, wherein the machine-learning model is a language model.
